(19) United States
(12) Patent Application Publication
(10) Pub. No.: US 2011/0000442 A1
(43) Pub. Date: Jan. 6, 2011

(54) Spookstik

(76) Inventors: Mark Kyle Herubin, Dallas, GA (US); Max Randall Wright, Rockmart, GA (US)

Correspondence Address: mark kyle herubin, 5633 hulseytown road, dallas, GA, 30157, US

(21) Appl. No.: 12/459,442

(22) Filed: Jul. 1, 2009

(51) Int. Cl. A01K 15/00

(52) U.S. Cl. 119/719

(57) ABSTRACT

Because the device is small and lightweight it can save the user time and money by not having the user setup expensive and heavy audio gear to try and reproduce these sounds. The device will allow the user to quickly move the sounds in 3d space around the animal simulating sounds occurring in nature or space around them. Because the sounds can be reproduced at will, the user can find potential problem sounds and train them out of the animal before injury can occur.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

Spookstik was developed to help in the equine and animal training industry. Thousands of injuries occur in the life cycle of training a horse or animal because of environment occurring sounds. Things like a gunshot, a car door slam, a dog bark, thunder or lighting are just a few of the many sounds that spook an animal. These sounds, at no given notice, will scare or spook a horse or animal, possibly injuring the trainer and or persons standing nearby.

To the best of our knowledge there is no product available in handheld form to allow a trainer to break the animal of these bad habits of spooking.

### BRIEF SUMMARY OF THE INVENTION

Spookstik is a handheld device that is used in the training of an animal. By reproducing sounds from a handheld device, the sounds can be directed at the animal and reproduce the effect of spooking the animal.

The Spookstik is moved in 3d space around the animal reproducing the effects of the sounds coming from different locations.

After training the animal with Spookstik the animal will become familiar with these sounds and not spook when presented with the real sounds out in the world. This would help save thousands of injuries a year.

We have found that daily use of the Spookstik will condition the animal into accepting the sounds and not continue the bad habits.

Because the Spookstik can be changed to reproduce any sounds, the user can find potential problems before they occur.

Because of the unique lightweight and handheld construction the user does not need expensive or heavy equipment, thus saving time and money setting up for training.

Because the Spookstik uses solid state electronics little or no damage occurs while using the training device in the field.

### BRIEF DESCRIPTION OF THE SEVERAL VIEWS OF THE DRAWINGS

FIG. 1 the preferred embodiment of the Invention.

FIG. 1a shows the handheld base unit housing the batteries, amplifier, sound reproducer, and controls.

FIG. 1b shows the speaker housing fitting cross section.

FIG. 1c shows the sound producing tube.

FIG. 1d shows the sound storage, reproduction controls location on the device.

FIG. 1e shows the amplification circuit location in the device.

FIG. 2 an alternate embodiment of the Invention

FIG. 2a shows the base unit.

FIG. 2b shows the sound storage, reproduction control location on the device.

FIG. 2c shows the sound producing tube.

FIG. 2d shows the speaker housing fitting cross section.

FIG. 2e shows the amplification circuit location in the device.

FIG. 3 an alternate embodiment of the Invention

FIG. 3a shows the base unit.

FIG. 3b shows the speaker housing fitting cross section.

FIG. 3c shows the sound producing tube.

FIG. 3d shows the sound storage, reproduction control and the amplification circuit which could clip to the users belt.

### DETAILED DESCRIPTION OF THE INVENTION

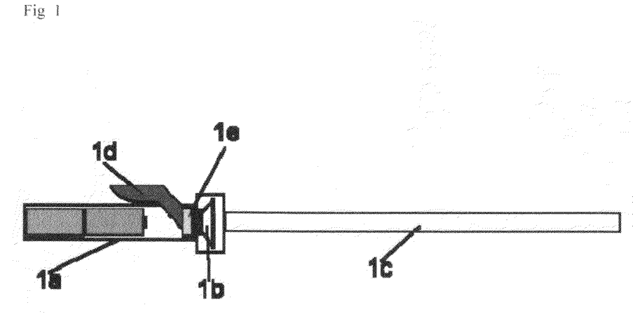

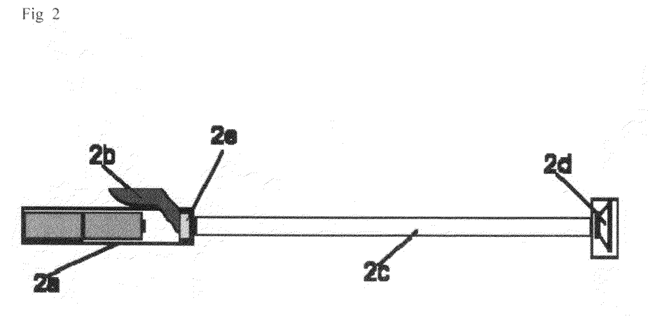

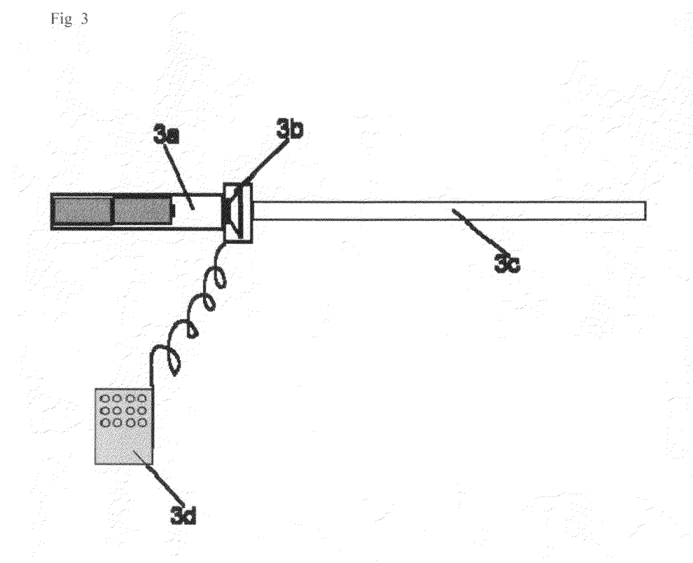

The preferred embodiment of Spookstik consists of a handheld device, light in weight and length 12 inches to 36 inches long. The device is broken down into five major categories.
One (FIG. 1a), the actual handheld case composed of a lightweight composite or alloy tubing. With a leather or rubber grip at one end and and open tube allowing sound to exit on the other.
Two (FIG. 1b), the speaker housing composed of similar materials with the speaker suspended in a bed or mount of silicon, glue or caulk.
Three (FIG. 1c), the sound reproducing tube.
Four (FIG. 1d), the sound storage/reproducing player.
Five (FIG. 1e), the low powered speaker amplification circuit location.

For one embodiment of the device component 1 is built out of PVC tubing material consisting of ½ inch to 3 inch diameter. Component 2 built out of a PVC fitting to house the speaker with threads on one end to accept component 3 a 12 inch to 36 inch PVC tube to allow the speaker to transmit the sound to the open end. The other side of component 2 the speaker fitting is turned down and threaded to accept component 1 base housing in which the user will hold in their hand. The base housing is of proper diameter to allow the installation of component 4 the sound storage/reproducing player, and batteries to power component 4 the amplification circuit.

The controls of the base unit are mounted external to allow easy access by the hand that is holding the unit. On the exterior, controls power on/off, forward to next sound, return to next sound, pause current sound, stop sound, control volume of sound up or down, and quick mute of sound.

The sound storage/player is not of unique design and can change based on current technology and pricing. We use current technology sound players.

The amplification circuit is not of unique design. We use current technology with low power usage and small form factor.

The unit is assembled so that the user can control all aspects of sound reproduction from the exterior without having to open the base unit to change anything other than replacing the batteries.

### The Key Factors Are:

1. Lightweight
2. Low power consumption
3. True and loud sound reproduction
4. Ease of use

By placing the batteries, amplification circuit, sound controls, and the speaker in the lower base unit an easy balance and weight distribution is obtained. Because the speaker is house in the lower section of the base unit sounds are pumped up through the exit tube to the outside world using very little amplification and little battery power promoting long life and lightweight. As the sound waves are forced up the tube they expand as they exit the small diameter PVC tubing creating a feeling of load amplification.

1. By combining ordinary items into a small lightweight handheld device a user can reproduce sounds found all around in his or hers environment. These reproductions can be used to train animals out of bad habits such as spooking or scaring causing undue harm and injury to the trainer and or persons located nearby.
